(19) United States
(12) Patent Application Publication
(10) Pub. No.: US 2005/0283393 A1
(43) Pub. Date: Dec. 22, 2005

(54) System and method for event-based forecasting

(75) Inventors: R. Stephen White, Waldoboro, ME (US); Carl Hamrin, Boothbay, ME (US); John Stoy, Boothbay, ME (US); Kim Slawson, Rochester, NY (US); Daniel Russell, Westbrook, ME (US); Rene Lebel, Candiac (CA); Patrick McDonnell, Montreal (CA); Guillaume Perron, Montreal (CA)

Correspondence Address: CHRIS A. CASEIRO, VERRILL DANA, LLP, ONE PORTLAND SQUARE, PORTLAND, ME, 04112-0586, US

(73) Assignee: New England 800 Company d/b/a Taction, Waldoboro, ME (US)

(21) Appl. No.: 10/993,419

(22) Filed: Nov. 19, 2004

Related U.S. Application Data
(60) Provisional application No. 60/523,800, filed on Nov. 20, 2003.

(51) Int. Cl. G06F 17/60

(52) U.S. Cl. 705/8

(57) ABSTRACT

A system and related method to forecast based on events defined by event segments. The system includes a database or set of databases populated with selectable event segments characterized by known information and predictive information deemed by the user to be relevant to a particular organization for which future resource allocation predictions are desired. Rather than evaluate past data summaries alone to predict future resource allocation requirements, the system and related method input raw data that may be parsed and analyzed in any selectable combination to produce one or more forecasts to produce resource allocation information. One use of the system and related method is to calculate staffing requirements for a contact center at a selectable level of granularity.

### CROSS REFERENCE TO RELATED APPLICATION

The present application claims the priority benefit of U.S. provisional patent application Ser. No. 60/523,800, filed Nov. 20, 2003, entitled “SYSTEM AND METHOD FOR EVENT-BASED FORECASTING” assigned to a common assignee. The entire contents of that prior application are incorporated herein by reference.

### BACKGROUND OF THE INVENTION

1. Field of the Invention

The present invention relates to systems and methods for forecasting staffing requirements. More particularly, the present invention relates to systems and methods for forecasting future staffing requirements based on related event information.

2. Description of the Prior Art

Many organizations that provide goods and services maintain (or outsource to) contact centers to handle their customer interactions. To handle those interactions-which come via phone, e-mail, fax, letter, etc.-the contact center managers must forecast the number and duration of interactions that will be received and the points in time when they will be received. Based on that forecast, the contact center can then be staffed with the proper number of employees throughout the day (and night) to handle interactions at the desired level of service. For contact centers, level of service is often defined for each response method as the percentage of contacts than can be answered within a stated period of time. For example, for telephone calls the required telephone service factor (TSF) may be 85% of all calls are answered within 30 seconds. The service factor for e-mail responses may be 90% within 24 hours. If too many employees are scheduled to work, unnecessary payroll expenditures are incurred. Too few and service levels suffer. Contact center managers are not the only managers who must predict staffing needs-managers of bank tellers, sales clerks, grocery cashiers, ticket takers and others must also forecast staff requirements accurately, or suffer the inevitable consequences. Such resource management may also be of value in inventory forecasting, just-in-time parts scheduling, and other activities in which optimization of resources is of interest.

Since customer interactions are likely to vary from day-to-day and week-to-week, contact center staffing requirements may change every week. To generate a scheduling plan, managers will typically create a forecast that looks three to four weeks into the future. To determine hiring and training requirements, forecasts may need to probe six months out.

Forecasts typically divide each day into 15-minute, 30-minute, or one-hour intervals (periods). Better results are usually achieved when the period length is shorter. For example, a forecast might show a manager how many staff full-time equivalents (FTEs) are needed for each of the 672 15-minute periods in a week. This data output becomes input to a workforce management (WFM) tool that schedules the right number of employees for that week. Staff schedules are often posted two to three weeks in advance.

Forecast tools currently available are typically provided by developers of WFM software. These tools use historical summary data as the basis for their forecasts. For instance, the number of customer interactions in the first week of January 2003 might be used as the basis for predicting the number of interactions that will occur in the first week of January 2004. Adjustments can then be made in light of additional factors, such as a new catalog drop that is expected to increase call volume or introduction of a new product line. The quality of the historical summary data, mathematical formulas chosen to process the data, and the accuracy of the manager's guesses at how additional factors will influence interaction volume all affect the quality of the outcome.

However, to suggest that an accurate forecast for 672 quarter-hour periods next month can be derived from copying last year's summary data and then manually tweaking it to arrive at next month's reality is mathematically improbable at best. Yet this approach is currently the backbone of most, if not all, forecast applications linked to WFM tools. This approach asks the user to predict the future by manipulating historical summary data. Summary data is the key to the problem. Summary data combines results from hundreds (or thousands) of individual stimuli, making it impossible to subsequently extract any individual contributing factors. A week of last year's response data in 15-minute periods is like a lump of dough sufficient for 672 slices of bread. Even though the dough is pushed around a bit to align with this year's day of week, and stretched a bit here or pinched off a bit there to account for anticipated factors affecting growth or shrinkage, the end result, once it has been baked, is likely to look a lot like other loaves of bread.

Therefore, what is needed is a system to provide a basis for accurate forecasting of resource allocation requirements, such as staffing requirements, within defined incremental time periods. Further, what is needed is such a system that takes into account selectable events and/or event combinations that may be as numerous and variable as desired, and that are related in some manner to the required forecast. The system should be compatible with WFM tools.

### SUMMARY OF THE INVENTION

It is an object of the present invention to provide a system to establish a basis for accurate forecasting of resource allocation requirements, including staffing requirements, within defined incremental time periods. It is also an object of the present invention to provide such a system that takes into account selectable events and/or event combinations that may be as numerous and variable as desired, and that are preferably related in some manner to the required forecast. The system is preferably compatible with WFM tools.

These and other objects are achieved with the present invention. The present invention is an event-based forecasting system and related method. The Event-Based Forecaster (EBF) correlates an array of information with outcomes, thereby enabling its user to predict resources responsive to the outcomes expected. The EBF provides the capability to identify granular information and then predict outcomes in a granular manner. While the detailed description herein of the preferred embodiment of the invention is directed to managing resources associated with a contact center, it is not limited thereto. Instead, the EBF may be employed as the framework for forecasting outcomes relevant to any resources allocation needs including, but not limited to, staffing needs. Moreover, the forecast outcomes may be employed to identify with greater clarity than has heretofore been available in prior predictive systems, the source or sources of the cause of the outcome(s) and the relative impact of each such source(s). In that way, a feedback loop may be established to enhance the prediction and improve the source identification in an iterative manner.

The present invention is a tool for projecting event-based in-bound contact center workloads better than any other tool or method, resulting in indisputable value. It is designed for use by contact center management to estimate in-bound contacts (direct responses and notifications of responses received by others)by date and hour (or other time period) of day to multiple contact centers which service multiple clients, each client having multiple campaigns comprised of multiple events, each event distributed to multiple lists, perhaps using varying collateral material and presenting different offers, but with each unique combination carrying a unique source (identifier) code, and handling multiple contact types. Furthermore, it is a tool that can be used by outside clients (via the web) for event entry and “what if” scenarios. As indicated, it is to be recognized that the EBF has applicability beyond Contact Center Management. For example, a circulation manager at a magazine may use the application in a “reverse engineering” fashion to determine what events need to happen—and when—in order to meet a circulation goal by a particular date.

The EBF has been created with the realization that an organization's future activity is generated from identifiable past, present and future events such as mailings and television ads, the release of new products and services, or other identifiable activities, each of which generates some proportion of questions or issues. EBF begins with the premise that customers attempt to contact an organization as the direct, and indirect result, of a multitude of specific, identifiable and quantifiable events and event segments, including promotions, trade shows, press releases, sales events, catalogs, advertising, and much more. The EBF examines raw data, not summary data, creating a computer model of contributing factors, variables and parameters for each “event segment” likely to affect the results predicted. For purposes of this description, an event segment is a collection of variables or parameters that begin at a specific point in time and are different in some way from other segments of an event. For example, the event may be a catalog mailing. One segment of the event may be the catalogs trucked to the U.S. Postal Service regional sectional center located in Merrifield, Va., with a planned “first in home” date of October 12^{th}. Another segment may be the portion of the catalog drop trucked to the regional sectional center near Philadelphia. The event is the fall catalog drop. The catalog drop to a regional sectional center near Philadelphia is one of the event segments of that event. The date of the drop, the number of catalogs, etc., are the variables and parameters making up that particular event segment. Each segment of the event is preferably analyzed separately, although it is possible to combine event segments in determining a forecast. Also, as noted, when analyzing the event segments individually, mini-forecasts based on the individual event segments individually, are generated. Combinations of mini forecasts may be summed to produce more comprehensive forecasts.

EBF provides a platform with which users capture and then analyze a multitude of parameters likely to affect the outcome of contributing multiple events and their event segments. Each contributes valuable forecast information on the life of an action or activity that may span many months. The process generates a unique and focused mini-forecast for each event segment captured or stored in a database of event segments referred to herein from time to time as information. Each mini-forecast can be visualized as a curve plotted against time with a data point for each quarter-hour period. There are lots of these curves and each can begin at a different point in time and end at a different point in time. A forecast, then, is the result of summing data points vertically for each quarter-hour period.

Event segment information comprising variables or parameters can be thought of as belonging to one of two sets: 1) the known or identifiable information that defines the event segment itself; and 2) the predictive information that defines likely responses to the event segment. For example for a direct-to-consumer business mailing of catalogs event, the following known or identifiable event segment information might define the event itself: the type and size of the catalog, the number of catalogs dropped, inventory included, special offers made and their duration, the published life of the catalog, whether all catalogs are dropped from one location or multiple locations and so on. Parameters defining predictive information responsive to an event segment include such things as the total number of responses expected, expressed as a percentage of catalogs dropped; the percent of responses that are likely to be orders, literature requests, problems or general inquiries (service types); the percent of responses expected to arrive via telephone, e-mail, fax, mail or in person (contact mode); and the average work time required to handle each service type via each contact mode. The known and predictive information are combined and analyzed, modeled, or otherwise evaluated as part of the EBF system to produce an outcome or set of outcomes that is a forecast of a resource requirement. As indicated above, the forecast may be narrow (a mini-forecast) or broad, as a function of the number of event segments to be analyzed. It is to be noted that outcomes may be fed back into the analysis for each event segment or set of event segments. The forecast may then be forwarded to a resource allocation function, such as a work force management tool.

The systematic capture, analysis and modeling of the individual event segments that drive contacts achieves highly desirable and interesting results. By combining a relatively large number of individual event segment forecasts, errors we humans may make tend to cancel one another. Forecast data stored is never based upon summary data but based on actual event segments and predictive information. By matching actual results attributed to each event segment back to each event segment forecast the model “learns.” So, we have with EBF a model that is inherently accurate and one that learns to be even more so.

Forward vs. Backward

Circulation managers (for example) can better predict with EBF the results of subscription campaigns contemplated—that is, successfully predict the number of new subscriptions, renewal subscriptions, gift subscriptions and gift renewals resulting from specific sales and marketing events. Because both forecast and response data stored is the raw data of event segments, circulation managers can also reverse the EBF model flow, asking, “What do I need to do in order to generate 100,000 new subscriptions? How many pieces of mail at this time of year, with this offer and this collateral material, must I mail to reach our goal by the end of the fiscal year?” With the idea that anyone in the organization through a specific action can influence future contacts, the EBF tracks all actions and events to determine future contact volumes in 15-minute (or 30-minute or 60-minute) intervals.

In one aspect of the invention, a method is provided for forecasting staffing requirements for an organization based on the occurrence of one or more events. The method includes the steps of inputting one or more event segments related to the one or more events into a database, analyzing the one or more event segments individually or in selectable combinations to produce one or more forecasts, and forwarding the one or more forecasts to a staffing allocation function for specifying future resource allocation for the organization. The event segments may be any variables and/or parameters related to the event including, for example, the type and size of a catalog, the number of catalogs dropped, inventory included, special offers made and their duration, the published life of the catalog, and whether all catalogs are dropped from one location or multiple locations, the total number of responses expected, expressed as a percentage of catalogs dropped; the percent of responses that are likely to be orders, literature requests, problems or general inquiries (service types); the percent of responses expected to arrive via telephone, e-mail, fax, mail or in person (contact mode); and the average work time required to handle each service type via each contact mode. The method includes the option of adding, subtracting, or modifying one or more of the event segments. It also includes the option of repeating the step of analyzing the one or more event segments and creating a new set of forecasts. One or more prior forecasts may be added as one or more event segments to be analyzed to produce a new set of forecasts. Variables from one or a collection of previous event segments and responses may be used as a basis for provisioning one or more new event segments. The method as claimed in claim 30 further comprising the step of retaining for access all forecasts produced. The event segments may be input into a database using a computer with a display and an input device, wherein one or more input tables visible on the display are associated with the database. The forecasts may be output as one or more output tables visible on the display, wherein the one or more output tables are associated with the database. There may be a manual override to modify one or more forecasts based on human input. Any event segment or event segment combination may be analyzed to produce a forecast related to the selected event segment or event segment combination.

In another aspect of the invention, a method is provided for forecasting an event to conduct based on a desired outcome. The method includes the steps of inputting one or more forecasted outcomes desired into a database, analyzing the one or more desired forecasted outcomes to produce one or more event segments, and relating the one or more produced event segments to one or more events to conduct to produce the one or more desired forecasted outcomes. The one or more events may be selected from the group consisting of, but not limited to, mailings, television ads, new product releases, new service releases, promotions, trade shows, press releases, sales events, catalogs, and advertising. The event segments may be selected from the group consisting of, but not limited to, the type and size of a catalog, the number of catalogs dropped, inventory included, special offers made and their duration, the published life of the catalog, and whether all catalogs are dropped from one location or multiple locations, the total number of responses expected, expressed as a percentage of catalogs dropped, the percent of responses that are likely to be orders, literature requests, problems or general inquiries (service types), the percent of responses expected to arrive via telephone, e-mail, fax, mail or in person (contact mode), and the average work time required to handle each service type via each contact mode.

The EBF accumulates and analyzes each input event and combinations of events created by the organization to feed a mathematical model that is precise enough to provide the user with a forecast that will more accurately determine their resource allocation needs. These and other advantages will become apparent upon review of the following detailed description of a preferred embodiment of the invention, the accompanying drawings, and the appended claims.

### BRIEF DESCRIPTION OF THE DRAWINGS

FIG. 1 is a simplified block representation of the event-based forecasting system of the present invention as a tool to forecast staffing needs for a contact center.

FIG. 2 is a simplified representation of a computer system including an input keyboard for inputting event segments into a database of the computer system and a display for viewing input tables and output tables of the event-based forecasting system.

FIG. 3 is a screen capture of a representation of a table of the present invention showing user input values.

FIG. 4 is a screen capture of a representation of a table of the present invention showing additional user input values.

FIG. 5 is a screen capture of a representation of a two-part table of the present invention showing contact center contact handling and contact information.

FIG. 6 is a screen capture of a representation of a table of the present invention showing a sample forecast model.

FIG. 7 is a screen capture of a representation of a table of the present invention showing a sample summary of tabulated data for an event.

FIG. 8 is a screen capture of a representation of a table of the present invention showing a template of selectable forecast information.

FIG. 9 is a screen capture of a representation of a table of the present invention showing a combination of a graph and a table representing contact information over a defined time period.

FIG. 10 is a screen capture of a representation of a table of the present invention showing sample event output data for a week from the screen of FIG. 9.

FIG. 11 is a screen capture of a representation of a table of the present invention showing sample event output data for each day of a week from the screen of FIG. 9.

FIG. 12 is a screen capture of a representation of a table of the present invention showing sample event output data for each specified time period from the screen of FIG. 9.

FIG. 13 is a screen capture of a representation of a table of the present invention showing summary information for the data collected.

FIG. 14 is a screen capture of a representation of a table of the present invention showing a sample summary graph of information for a single event for a single contact type.

### DETAILED DESCRIPTION OF THE PREFERRED EMBODIMENT

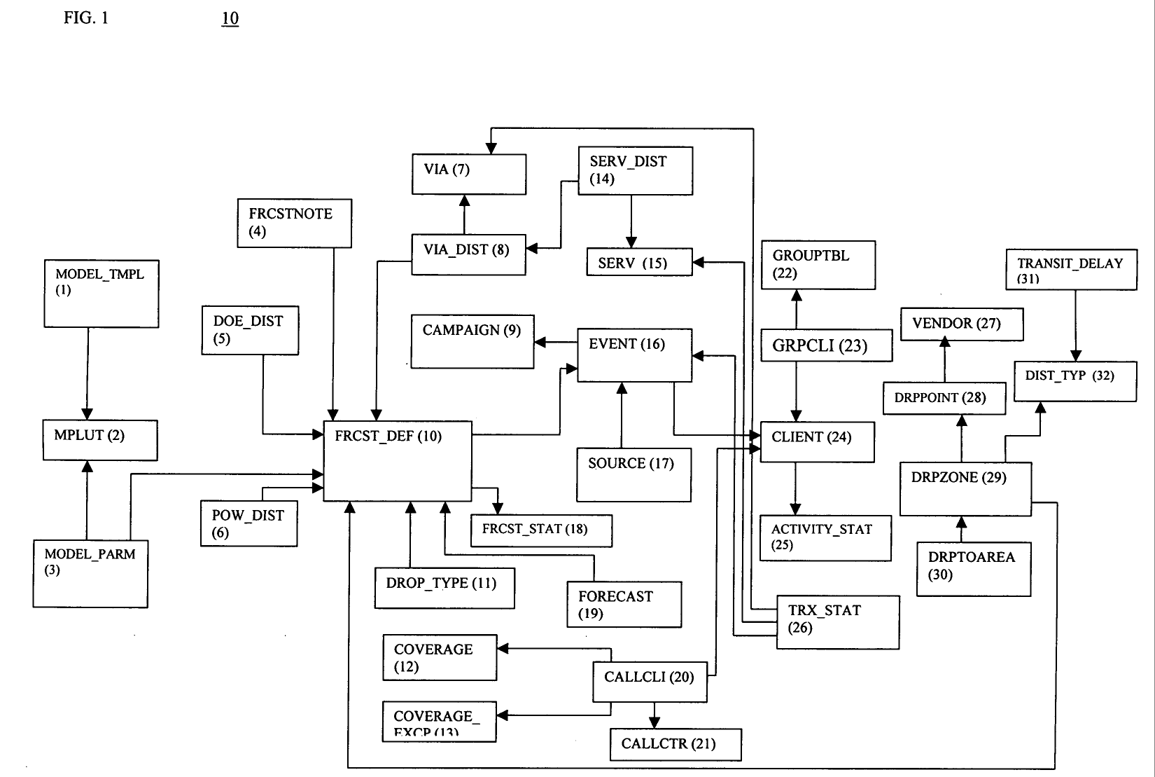

An Event-Based Forecasting (EBF) system 10 of the present invention is represented conceptually in FIG. 1 in the context of a contact center organization. It is to be understood that other types of organizations may employ the EBF system for the purpose of forecasting resource allocation requirements The EBF system 10 includes a plurality of data input tables and output tables. The EBF system 10 includes one or more computer programs to analyze data as event segments input to the one or more data input tables to produce predictive outcomes of resource allocation information, such as staffing needs. The output of the analysis may be forwarded to a resource allocation function, such as a work force management tool, for specific resource allocation.

The following naming conventions and table definitions relate to FIG. 1 and provide the basis for the comprehensive information analysis and event forecasting. It is to be understood that common names used in a plurality of tables represent the same information set.

Column Naming Conventions

The EBF database uses the following convention for the column names:

<TABLE_NAME>_<COLUMN_TYPE>

where <TABLE_NAME> indicates the table where this column is defined and <COLUMN_TYPE> indicates type of data in this column.

Here is a list of the more common types:

NB=a unique numeric key generated by the dbms when the row is inserted

CD=a human assigned alpha-numeric code indicating a type of row

ID=a human assigned alpha-numeric identifier

DESC=a textual description of the row

DT=a date

TM=a time

COUNT=a numeric count

MIN=minutes

TOT=total

FRAC=fraction

The following columns appear in all tables except the FRECAST table:

AUDNM=the name of the individual that last inserted or updated this row

AUDTS=a time stamp indicating when this row was last inserted or updated

Key to tables in the diagram:

Tables 2, 7, 9, 15, 17, 18, 21, 22, 25, and 32 of FIG. 1 represent code validation tables. These codes are not client specific. Tables 1, 3, 5, and 6 represent model template tables, holding templates for transaction distribution models. The templates are not client specific. Tables 4, 8, 10-14, 16, 20, 23, 24, and 27-31 represent data specifying parameters for a forecast for a specific client and event. Table 19 represents the result data for a specific forecast. Table 26 represents actual transaction statistics.

Table Information

Table ACTIVITY_STAT
Table defining valid client activity status codes. These are not client
specific, they may be used for all clients.

| Name | Type | P | M |
|---|---|---|---|
| ACT_STAT_CD | char(1) | Yes | Yes |
| ACT_STAT_DESC | char(50) | No | No |
| ACT_STAT_AUDNM | char(8) | No | No |
| ACT_STAT_AUDTS | timestamp | No | No |

Column ACT_STAT_CD
A code indicating the activity status of client, like A = Active,
I = Inactive, P = Prospect, etc..

Table CALLCLI
Table to define the call centers that will cover the transactions.

| Name | Type | P | M |
|---|---|---|---|
| CALLCTR_CD | char(5) | Yes | Yes |
| CLIENT_ID | char(4) | Yes | Yes |
| COVERAGE_ID | integer | No | No |
| COVERAGE_POW_OCCUR | smallint | No | No |
| COVERAGE_EXCP_ID | integer | No | No |
| COVERAGE_EXCP_DT | date | No | No |
| COVERAGE_EXCP_TM | time | No | No |

Table CALLCTR
This table defines the valid Call Center ids. The call centers are not
necessarily client specific, and may handle transactions for multiple
clients.

| Name | Type | P | M |
|---|---|---|---|
| CALLCTR_CD | char(5) | Yes | Yes |
| CALLCTR_DESC | char(50) | No | No |
| CALLCTR_AUDNM | char(8) | No | No |
| CALLCTR_AUDTS | timestamp | No | No |

Table CAMPAIGN
Table defining valid client campaign codes.

| Name | Type | P | M |
|---|---|---|---|
| CLIENT_ID | char(4) | Yes | Yes |
| CAMPAIGN_CD | char(12) | Yes | Yes |
| CAMPAIGN_DESC | char(50) | No | No |
| CAMPAIGN_FROM_DT | date | No | No |
| CAMPAIGN_FROM_TM | time | No | No |
| CAMPAIGN_TO_DT | date | No | No |
| CAMPAIGN_TO_TM | time | No | No |
| CAMPAIGN_AUDNM | char(8) | No | No |
| CAMPAIGN_AUDTS | timestamp | No | No |

Column CAMPAIGN_CD
An alphanumeric, mnemonic code identifying a client campaign.
Column CAMPAIGN_FROM_DT
The first date this campaign code is valid.
Column CAMPAIGN_FROM_TM
The time of day on the first date this campaign code is valid.
Column CAMPAIGN_TO_DT
The last date this campaign code is valid
Column CAMPAIGN_TO_TM
The time of day after which this campaign code is no longer valid.

Table CLIENT
Table defining the client IDs used for forecasting,
and their current status.

| Name | Type | P | M |
|---|---|---|---|
| CLIENT_ID | char(4) | Yes | Yes |
| ACT_STAT_CD | char(1) | No | No |
| CLIENT_DESC | char(30) | No | No |
| CLIENT_AUDNM | char(8) | No | No |
| CLIENT_AUDTS | timestamp | No | No |

Column CLIENT_ID
A unique mnemonic alphanumeric code identifying a client.

Table COVERAGE
Table defining the distribution of transactions to the call center
over the periods of the week.

| Name | Type | P | M |
|---|---|---|---|
| COVERAGE_ID | integer | Yes | Yes |
| COVERAGE_POW_OCCUR | smallint | Yes | Yes |
| COVERAGE_POW_PERCENT | float | No | No |
| COVERAGE_AUDNM | char(8) | No | No |
| COVERAGE_AUDTS | timestamp | No | No |

Table COVERAGE_EXCP
Table to define Holiday and other exceptions to the “normal”
schedule for distribution of transactions.

| Name | Type | P | M |
|---|---|---|---|
| COVERAGE_EXCP_ID | integer | Yes | Yes |
| COVERAGE_EXCP_DT | date | Yes | Yes |
| COVERAGE_EXCP_TM | time | Yes | Yes |
| COVERAGE_EXCP_HR_PERCENT | float | No | No |
| COVERAGE_EXCP_AUDNM | char(8) | No | No |
| COVERAGE_EXCP_AUDTS | timestamp | No | No |

Table DIST_TYPE
This table defines valid distribution codes, describing distribution
types like USPS mail, FEDEX, etc. The distribution types are not
client specific; they may be used across multiple clients.

| Name | Type | P | M |
|---|---|---|---|
| DIST_TYPE_CD | char(8) | Yes | Yes |
| DIST_TYPE_DESC | char(50) | No | No |
| DIST_TYPE_AUDNM | char(8) | No | No |
| DIST_TYPE_AUDTS | timestamp | No | No |

Column DIST_TYPE_CD
A code specifying a specific distribution method. Examples:
MASSMAIL, USPS, UPSGROUND.

Table DOE_DIST
Table holding the DayOfEvent (DOE) relative distribution of transactions
of for a forecast derived at by applying the specific distribution model
chosen for that forecast.

| Name | Code | Type | P | M |
|---|---|---|---|---|
| FRCST_DEF_NB | FRCST_DEF_NB | integer | Yes | Yes |
| DOE_DIST_DAY | DOE_DIST_DAY | smallint | Yes | Yes |
| DOE_DIST_DAY_{—} | DOE_DIST_DAY_{—} | float | No | No |
| PCT | PCT | | | |

Column DOE_DIST_DAY
An integer specifying the relative number of the day for the event.
Column DOE_DIST_DAY_PCT
A fraction indicating the percentage of all transactions for an event
expected for the day of the event. The total of all
DOE_DIST_DAY_PCT must equal 1.00 (100%)

Table DROPTYPE
This table should probably be renamed DROPPART. As far as we recall
the original use of it was to define the distribution of media drops
over time when delayed drops are used.

| Name | Type | P | M |
|---|---|---|---|
| FRCST_DEF_NB | integer | Yes | Yes |
| DROPTYPE_OCCUR | integer | Yes | Yes |
| DROPTYPE_DELAY | smallint | No | Yes |
| DROPTYPE_PCT | float | No | No |
| DROPTYPE_AUDNM | char(8) | No | No |
| DROPTYPE_AUDTS | timestamp | No | No |

Column DROPTYPE_OCCUR
The relative number of the media drop, 1 for the first drop,
2 for the second, etc.
Column DROPTYPE_DELAY
The delay for this drop relative to the start of the event.
Column DROPTYPE_PCT
A fraction indicating the percentage of the media dropped in
this occurrence.

Table DRPPOINT
Table specifying in which states the vendor's distribution points
are located.

| Name | Type | P | M |
|---|---|---|---|
| VENDOR_ID | char(8) | Yes | Yes |
| DRPPOINT_ID | integer | Yes | Yes |
| DRPPOINT_ST | char(2) | No | No |

Column DRPPPOINT_ID
A unique numeric key (serial key) identifying a specific distribution
drop point.
Column DRPPOINT_ST
State code identifying the state in which the distribution drop point
is located.

Table DRPTOAREA
Table defining the distribution of material over target states for
the parent DRPZONE record.

| Name | Type | P | M |
|---|---|---|---|
| FRCST_DEF_NB | integer | Yes | Yes |
| VENDOR_ID | char(8) | Yes | Yes |
| DRPPOINT_ID | integer | Yes | Yes |
| DIST_TYPE_CD | char(8) | Yes | Yes |
| DRPZONE_DT | date | Yes | Yes |
| DRPTOAREA_TO_ST | char(2) | Yes | Yes |
| DRPTOAREA_ST_PCT | float | No | No |
| DRPTOAREA_AUDNM | char(8) | No | No |
| DRPTOAREA_AUDTS | timestamp | No | No |

Column DRPTOAREA_TO_ST
State code specifying the target state for the share of
distribution material defined in this row.
Column DRPTOAREA_ST_PCT
The fraction (percentage) of the materials defined in the parent
DRPZONE record that is targeted
for the state defined in the DRPTOAREA column.

Table DRPZONE
Table defining the distribution in time and space of all material dropped.

| Name | Type | P | M |
|---|---|---|---|
| FRCST_DEF_NB | integer | Yes | Yes |
| VENDOR_ID | char(8) | Yes | Yes |
| DRPPOINT_ID | integer | Yes | Yes |
| DIST_TYPE_CD | char(8) | Yes | Yes |
| DRPZONE_DT | date | Yes | Yes |
| DRPZONE_PCT | float | No | No |
| DRPZONE_AUDNM | char(8) | No | No |
| DRPZONE_AUDTS | timestamp | No | No |

Column DRPZONE_DT
The drop date for the distribution defined in this row.
Column DRPZONE_PCT
The fraction of all distribution material that is dropped at this
drop point and on this date.

Table EVENT
Table containing specific data about a client event.

| Name | Type | P | M |
|---|---|---|---|
| CLIENT_ID | char(4) | Yes | Yes |
| EVENT_ID | char(4) | Yes | Yes |
| CAMPAIGN_CD | char(12) | No | No |
| CAM_CLIENT_ID | char(4) | No | No |
| EVENT_DESC | char(30) | No | No |
| EVENT_LATEST_FKEY | integer | No | No |
| EVENT_CURRENT_FKEY | integer | No | No |
| EVENT_AUDNM | char(8) | No | No |
| EVENT_AUDTS | timestamp | No | No |

Column EVENT_ID
An id assigned to the client specific event.
Column EVENT_LATEST_FKEY
A pointer to the latest forecast calculation for this event,
the FRCST_DEF_NB value.
Column EVENT_CURRENT_FKEY
A pointer to the currently used forecast calculation for this event,
the FRCST_DEF_NB value.

Table FORECAST
Table holding the results of the calculated forecast predictions.

| Name | Type | P | M |
|---|---|---|---|
| FRCST_DEF_NB | integer | Yes | Yes |
| FORECAST_TXN_DT | date | No | No |
| FORECAST_TXN_PER | smallint | No | No |
| VIA_CD | char(1) | No | No |
| SERV_CD | char(1) | No | No |
| FORECAST_TXN_COUNT | integer | No | No |
| FORECAST_TXN_MIN | float | No | No |

Column FORECAST_TXN_DT
The date for which this transaction count was calculated.
Column FORECAST_TXN_PER
The period number of the day for which this transaction
count was calculated.
The period number ranges between 0 and 95 for 15-minute periods,
between 0 and 47 for 30-minute periods, and between 0 and 23 for
hour periods.
Column FORECAST_TXN_COUNT
The forecasted number of transactions for this date, period,
modality and service code..
Column FORECAST_TXN_MIN
The forecasted total minutes of agent contact time for this date, period,
modality and service code.

Table FRCST_DEF
This is the forecast master definition table, in essence the “King Pin”
record for the forecast. There is one row in this table for each defined
forecast. All other tables defining particulars about the forecast are
linked to this table via the FRCST_DEF_NB key.
Optional descriptive notes about the particular forecasts can be made
in the FRCSTNOTE table.

| Name | Type | P | M |
|---|---|---|---|
| FRCST_DEF_NB | integer | Yes | Yes |
| FRCST_STAT_CD | char(1) | No | No |
| CLIENT_ID | char(4) | No | Yes |
| EVENT_ID | char(4) | No | Yes |
| FRCST_DEF_DESC | char(50) | No | No |
| FRCST_DEF_FROM_DT | date | No | No |
| FRCST_DEF_FROM_TM | time | No | No |
| FRCST_DEF_TO_DT | date | No | No |
| FRCST_DEF_TO_TM | time | No | No |
| FRCST_DEF_DROP_TOT | integer | No | No |
| FRCST_DEF_ORD_PCT | float | No | No |
| FRCST_DEF_UNK_PCT | float | No | No |
| FRCST_DEF_ANCESTOR | integer | No | No |
| FRCST_DEF_AUDNM | char(8) | No | No |
| FRCST_DEF_AUDTS | timestamp | No | No |

Column FRCST_DEF_NB
A unique key (serial key) identifying a particular forecast. This is used
as a foreign key in all tables defining particulars about this forecast.
Column FRCST_DEF_DESC
Descriptive text about this forecast.
Column FRCST_DEF_FROM_DT
The first date this forecast applies.
Column FRCST_DEF_FROM_TM
The time of day on the first date after which this forecast does apply.
Column FRCST_DEF_TO_DT
The last date this forecast applies.
Column FRCST_DEF_TO_TM
The time of day on the last date after which this forecast does not apply.
Column FRCST_DEF_DROP_TOT
The total number of pieces (catalogs/flyers/mailers) to be dropped.
Column FRCST_DEF_ORD_PCT
The fraction (percent) of transactions expected to be orders.
Column FRCST_DEF_UNK_PCT
The fraction (percentage) of transactions expected to be of unknown type.
Column FRCST_DEF_ANCESTOR
A pointer to a previous forecast that this forecast replaces.

Table FRCST_STAT
Table defining valid forecast status codes. The codes are not client
specific, they may be used across all clients.

| Name | Type | P | M |
|---|---|---|---|
| FRCST_STAT_CD | char(1) | Yes | Yes |
| FRCST_STAT_DESC | char(50) | No | No |
| FRCST_STAT_AUDNM | char(8) | No | No |
| FRCST_STAT_AUDTS | timestamp | No | No |

Column FRCST_STAT_CD
Code indicating the status of a forecast. Example A = Active, I = Inactive,
P = Pending, etc

Table FRCSTNOTE
Table holding descriptive notes about specific forecasts. There can be
an optional number of rows in this table for each forecast defined in
the FRSCT_DEF table.

| Name | Type | P | M |
|---|---|---|---|
| FRCST_DEF_NB | integer | Yes | Yes |
| FRCSTNOTE_TS | timestamp | Yes | Yes |
| FRCSTNOTE_TEXT | long | No | No |
| | varchar | | |
| FRCSTNOTE_AUDNM | char(8) | No | No |
| FRCSTNOTE_AUDTS | timestamp | No | No |

Column FRCSTNOTE_TS
A timestamp indicating when this note was added.
Column FRCSTNOTE_TEXT
The text of this note. The text can be of any length.

Table GROUPTBL
Table defining valid group codes used to characterize clients as per
their type, 24/7. after hours, gift clients, etc.

| Name | Type | P | M |
|---|---|---|---|
| GROUPTBL_CD | char(8) | Yes | Yes |
| GROUPTBL_DESC | char(50) | No | No |
| GROUPTBL_AUDNM | char(8) | No | No |
| GROUPTBL_AUDTS | timestamp | No | No |

Column GROUPTBL_CD
Alphanumeric code used to characterize clients.

Table GRPCLI
Table holding links to aggregate clients into groups for forecasting
purposes. A client can belong to one or several groups

| Name | Type | P | M |
|---|---|---|---|
| CLIENT_ID | char(4) | Yes | Yes |
| GROUPTBL_CD | char(8) | Yes | Yes |

Table MODEL_PARM
This table holds the specific transaction distribution model parameters
for the chosen model for a specific forecast.

| Name | Type | P | M |
|---|---|---|---|
| FRCST_DEF_NB | integer | Yes | Yes |
| MPLUT_TYPE | char(4) | Yes | Yes |
| MPLUT_NAME | char(12) | Yes | Yes |
| MODEL_PARM_VER | smallint | Yes | Yes |
| MODEL_PARM_SEQ_NB | smallint | Yes | Yes |
| MODEL_PARM_FLOAT | float | No | No |
| MODEL_PARM_TEXT | char(250) | No | No |
| MODEL_PARM_AUDNM | char(8) | No | No |
| MODEL_PARM_AUDTS | timestamp | No | No |

Table MODEL_TMPL
Table to contain formulae for mathematical transaction distribution
models. These are not specific instances of a model, but rather
general formulae. The MODEL_TMPLTEXT column is
intended to hold any mathematical formula.

| Name | Type | P | M |
|---|---|---|---|
| MPLUT_TYPE | char(4) | Yes | Yes |
| MPLUT_NAME | char(12) | Yes | Yes |
| MODEL_TMPL_VER | smallint | Yes | Yes |
| MODEL_TMPL_SEQ_NB | smallint | Yes | Yes |
| MODEL_TMPL_FLOAT | float | No | Yes |
| MODEL_TMPL_TEXT | char(250) | No | No |
| MODEL_TMPL_AUDNM | char(8) | No | No |
| MODEL_TMPL_AUDTS | timestamp | No | No |

Table MPLUT
This table is a link record between the specific transaction
distribution model used for a forecast and the row in table
MODEL_PARM holding the specific model parameters for this
instance of the model.

| Name | Type | P | M |
|---|---|---|---|
| MPLUT_TYPE | char(4) | Yes | Yes |
| MPLUT_NAME | char(12) | Yes | Yes |
| MPLUT_DESC | char(50) | No | No |
| MPLUT_AUDNM | char(8) | No | No |
| MPLUT_AUDTS | timestamp | No | No |

Table POW_DIST
Table holding the relative distribution of transactions over the
periods of the week (POW) for a forecast derived at by applying
the specific distribution model chosen for that forecast.

| Name | Type | P | M |
|---|---|---|---|
| FRCST_DEF_NB | integer | Yes | Yes |
| POW_DIST_PER | smallint | Yes | Yes |
| POW_DIST_PCT | float | No | No |

Column POW_DIST_PER
A number specifying the period of the week. There are 168, 336 or 672
periods/week for 60, 30 or 15 minute periods.
Column POW_DIST_PCT
A fraction indicating the percentage of transactions expected to occur
during this period of the week. The total of POW_DIST_PCT
for all periods of the week must equal 1.00 (100%)

Table SERV
Table defining valid transaction service codes.
The service codes are not client specific, they may be used
for all clients.

| Name | Type | P | M |
|---|---|---|---|
| SERV_CD | char(1) | Yes | Yes |
| SERV_DESC | char(50) | No | No |
| SERV_AUDNM | char(8) | No | No |
| SERV_AUDTS | timestamp | No | No |

Column SERV_CD
Code indicating the type of service of a transaction. Examples are:
O = Order
P = Problems
L = Literature request
C = Change of address

Table SERV_DIST
Table holding data about the chosen distribution of transactions over
service codes for a specific forecast and modality.

| Name | Type | P | M |
|---|---|---|---|
| VIA_CD | char(1) | Yes | Yes |
| FRCST_DEF_NB | integer | Yes | Yes |
| SERV_CD | char(1) | Yes | Yes |
| SERV_DIST_FRAC | float | No | No |
| SERV_DIST_MIN | float | No | No |
| SERV_DIST_AUDNM | char(8) | No | No |
| SERV_DIST_AUDTS | timestamp | No | No |

Column SERV_DIST_FRAC
The fraction (percent) of all transactions for a specific forecast
and modality (VIA_CD) that will be of this service type
(SERV_CD). The sum of SERV_DIST_FRAC over all
modalities for a specific forecast must equal 1.00.
Column SERV_DIST_MIN
The estimated average call center transaction time in minutes for the
specific forecast (FRCST_DEF_NB), modality (VIA_CD)
and service type (SERV_CD)

Table SOURCE
Table defining valid source codes for a specific client and event.
The same source code may be used by other clients.

| Name | Type | P | M |
|---|---|---|---|
| CLIENT_ID | char(4) | Yes | Yes |
| EVENT_ID | char(4) | Yes | Yes |
| SOURCE_CD | char(12) | Yes | Yes |
| SOURCE_DESC | char(50) | No | No |
| SOURCE_FROM_DT | date | No | No |
| SOURCE_FROM_TM | time | No | No |
| SOURCE_TO_DT | date | No | No |
| SOURCE_TO_TM | time | No | No |
| SOURCE_AUDNM | char(8) | No | No |
| SOURCE_AUDTS | timestamp | No | No |

Column SOURCE_CD
An assigned code indicating the media source that generated the
contact center transaction.
Column SOURCE_FROM_DT
The first date that this source code is valid.
Column SOURCE_FROM_TM
The time of day on the first availability date that this source code is valid.
Column SOURCE_TO_DT
The last date that this source code is valid.
Column SOURCE_TO_TM
The time of day on the last availability date after which this source code
is no longer valid

Table TRANSIT_DELAY
Table holding distribution transit delays between different states for
different distribution types.

| Name | Type | P | M |
|---|---|---|---|
| DIST_TYPE_CD | char(8) | Yes | Yes |
| TRANSIT_DELAY_FR_ST | char(2) | Yes | Yes |
| TRANSIT_DELAY_TO_ST | char(2) | Yes | Yes |
| TRANSIT_DELAY_DAYS | smallint | No | No |
| TRANSIT_DELAY_AUDNM | char(8) | No | No |
| TRANSIT_DELAY_AUDTS | timestamp | No | No |

Column TRANSIT_DELAY_FR_ST
Code indicating state from which distribution starts.
Column TRANSIT_DELAY_TO_ST
Code indicating the target state for distribution.
Column TRANSIT_DELAY_DAYS
The distribution delay, or transit time, in days between the two states.

Table TRX_STAT
Table holding actual transaction statistics for a specific client event.

| Name | Type | P | M |
|---|---|---|---|
| CLIENT_ID | char(4) | Yes | Yes |
| EVENT_ID | char(4) | Yes | Yes |
| TRX_STAT_TRX_DT | date | Yes | Yes |
| TRX_STAT_TRX_PER | smallint | Yes | Yes |
| VIA_CD | char(1) | No | No |
| SERV_CD | char(1) | No | No |
| TRX_STAT_TRX_COUNT | integer | No | No |
| TRX_STAT_TRX_MIN | float | No | No |
| TRX_STAT_AUDNM | char(8) | No | No |
| TRX_STAT_AUDTS | timestamp | No | No |

Column TRX_STAT_TRX_DT
The date for which this data pertains.
Column TRX_STAT_TRX_PER
The period of the day that this data pertains.
Column TRX_STAT_TRX_COUNT
The actual number of contact center transactions for this date, period,
modality and service code.
Column TRX_STAT_TRX_MIN
The actual total minutes of agent contact time for this client, event, date,
period, modality and service code.

Table VENDOR
Table to hold distribution vendor name and id.

| Name | Type | P | M |
|---|---|---|---|
| VENDOR_ID | char(8) | Yes | Yes |
| VENDOR_NAME | char(50) | No | No |
| VENDOR_AUDNM | char(8) | No | No |
| VENDOR_AUDTS | timestamp | No | No |

Column VENDOR_ID
Distribution vendor id code.
Column VENDOR_NAME
The name of the distribution vendor.

Table VIA
Table defining valid VIA codes. VIA codes indicates the modality of a
transaction, i.e. how a transaction reached the contact center.
The VIA codes are not client specific, they may be used for all clients.

| Name | Type | P | M |
|---|---|---|---|
| VIA_CD | char(1) | Yes | Yes |
| VIA_DESC | char(50) | No | No |
| VIA_AUDNM | char(8) | No | No |
| VIA_AUDTS | timestamp | No | No |

Column VIA_CD
Code for the modality of a transaction. Examples are:
L = Live phone call
E = Email
M = “White mail” (USPS)
F = Fax message.

Table VIA_DIST
Table holding data about the via distribution model chosen for a
specific forecast. The sum of the VIA_DIST_FRAC values for
all rows for a specific forecast (FRCST_DEF_NB) must equal 1.00

| Name | Type | P | M |
|---|---|---|---|
| VIA_CD | char(1) | Yes | Yes |
| FRCST_DEF_NB | integer | Yes | Yes |
| VIA_DIST_FRAC | float | No | No |
| VIA_DIST_AUDNM | char(8) | No | No |
| VIA_DIST_AUDTS | timestamp | No | No |

Column VIA_DIST_FRAC
The estimated fraction (percent) of all transactions for the specific forecast
that will use this modality as indicated by the value of the
VIA_CD column.

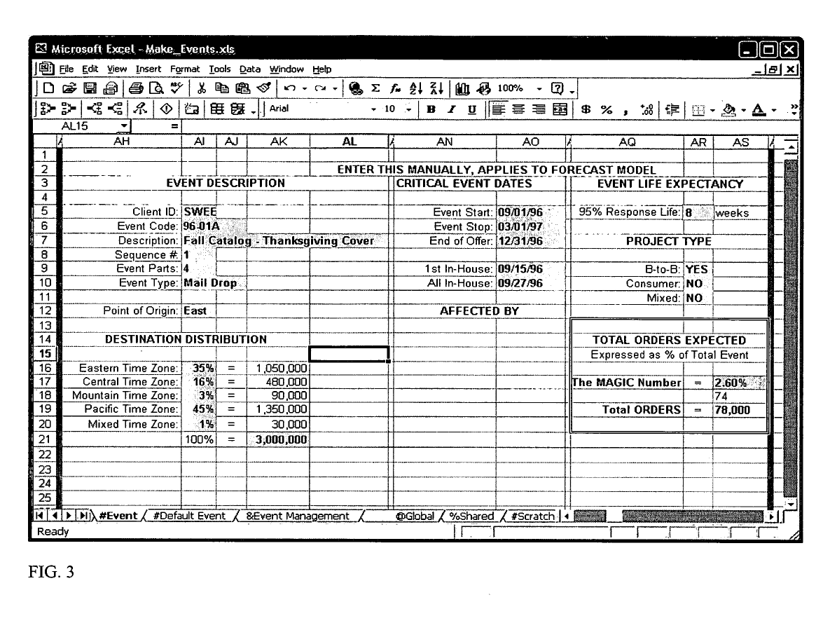

The first step in using the EBF is to define each Event. Input and output information for each defined Event are summarized into tables that hold data for each week, day, and time period of the events. The steps in defining an event include: 1) Event Parameters; 2) Event Response Distribution; 3) Coverage; 4) Day of Event Section; 5) Multiple Events View; 6) Day of Week View; 7) Period of Week View; 8) Event Output Per Week; 9) Event Output Per Day; 10) Event Output Per Period; 11) Summary; and 12) Graph. FIGS. 3-14 provide example spreadsheet representations of the indicated steps. It is to be understood that those representations are illustrative and not exhaustive.

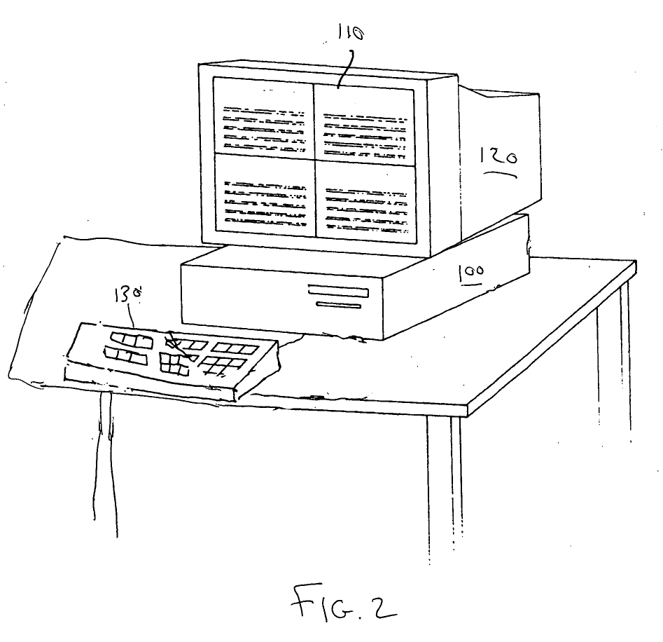

As illustrated in FIG. 2, the EBF system 10 may be established in a computing system, represented by computing system 100. the computing device may be a standalone desktop computer, a mainframe computer, a portable computer, or any combination thereof and/or a plurality of any one or more thereof. The computing system 100 includes one or more databases 110 accessible through the computing system 100, one or more displays 120 for viewing data of the database, input tables, and output tables, and an input device 130, such as a keyboard or keypad, to input data, initiate analysis of data, and calling up of output forecast.

FIG. 3 shows Event Parameters. On this screen, the user inputs values into all the areas shaded in blue. These values define the general characteristics of a single event. The “Event Description” section contains general data about the event. The “Destination Distribution” section defines where the mail is being sent, as a percentage of the total number of mail pieces. These percentages are currently figured by semi-manually analyzing the destination zip codes and calculating the time zone percentages. In the EBF, a module performs this analysis in an automated fashion. “Critical Event Dates” describe when the event starts and stops. The “1^{st} In-House” and “All In-House” dates are preferably calculated by the EBF, basing the calculation on the locations of the mail drops and data specific to the mail drop locations. The user may override the calculated dates by manually entering dates, if necessary. The “Event Life Expectancy” section determines the length of the event. The “Project Type” section is used for coverage at the contact center, but its use may not be fully defined. Under “Total Orders Expected”, the “The MAGIC Number” field is the percentage of the total event's contacts that will result in orders. All the input fields are preferably in a form-based query, so the user can fill in only the information they have, and the EBF provides default values for the rest.

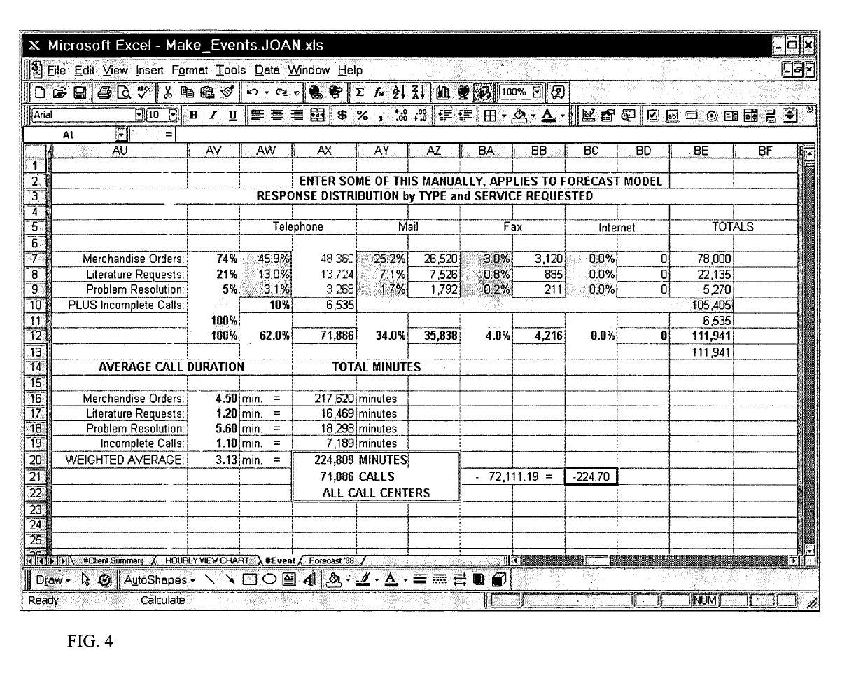

FIG. 4 shows Event Response Distribution. On this screen, the user enters data into all the fields shaded in blue and green. In the EBF, the user enters data into a form-based screen that prompts for the information for each contact type, and does not restrict to a limited set of contact types. The values entered in the “Average Call Duration” section should be derived from actual data, if available. The EBF may provide this data, if it is available. (The calculations to the right of the yellow box are for testing and validation purposes only.)

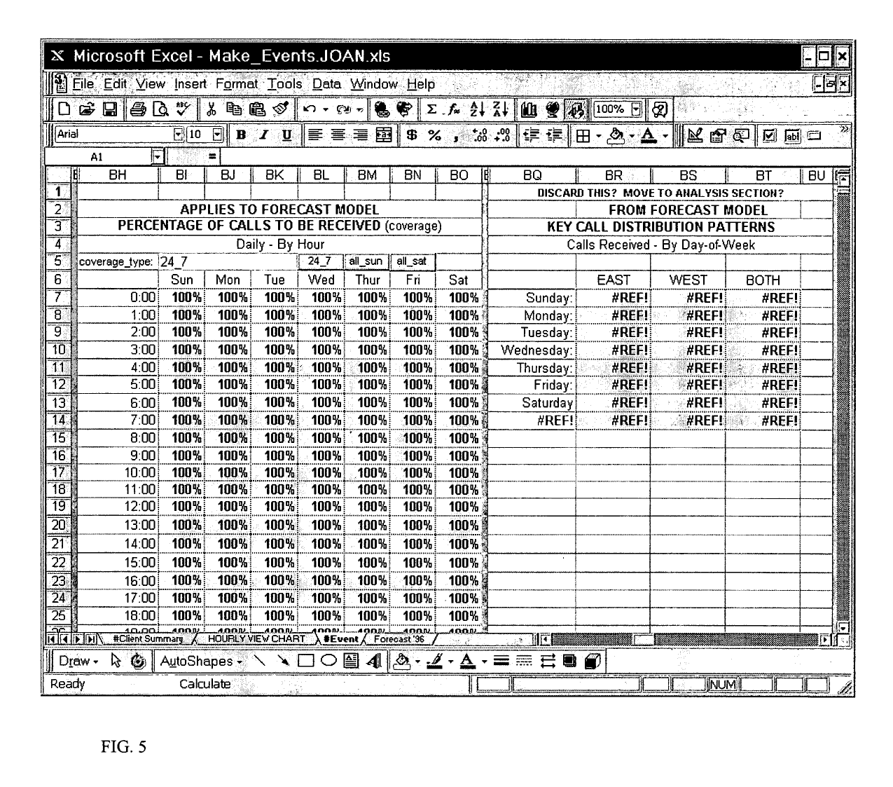

FIG. 5 shows Coverage. This screen is in two parts. On the left is a table that defines the amount of contacts that a single contact center will handle. This is expressed as a percentage of the total contacts during a single time period. While only one coverage table as created is shown, others may be generated as well. The right side of this screen provides information on where the contacts are received from, based on the time zone, zip code, and drop locations specified for the event.

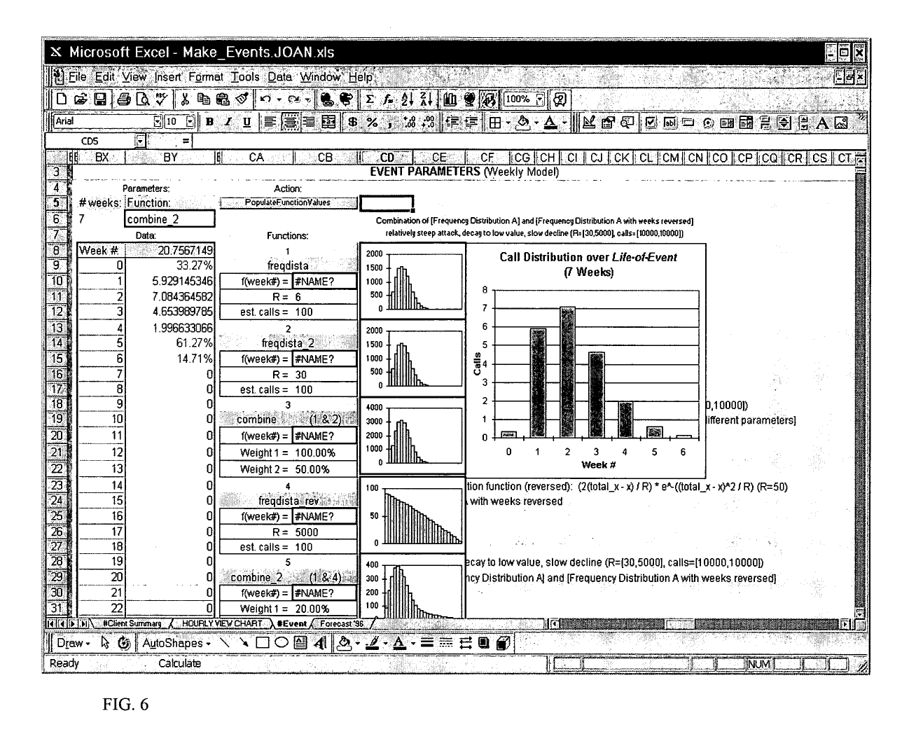

FIG. 6 shows Day of Event (Weekly) template selection. On this screen, the user selects the template to use for the “day of event,” i.e. the weekly forecast model. The small graphs down the middle of the screen are different templates that the user can select. Each template defines a different contact “trend”. Each template has parameters, or weighting factors, that the user can specify to change the character of the template curve, such as changing the length (width), and height. These templates are based on the “Rayleigh” curve function. When a template is selected, the column on the left side of the screen is filled in with percentages of contacts each week. The larger chart on the right side of the screen shows the result of the user's selections. In this application, only calls to a contact center are forecasted, however, the EBF provides for forecasting of each contact type.

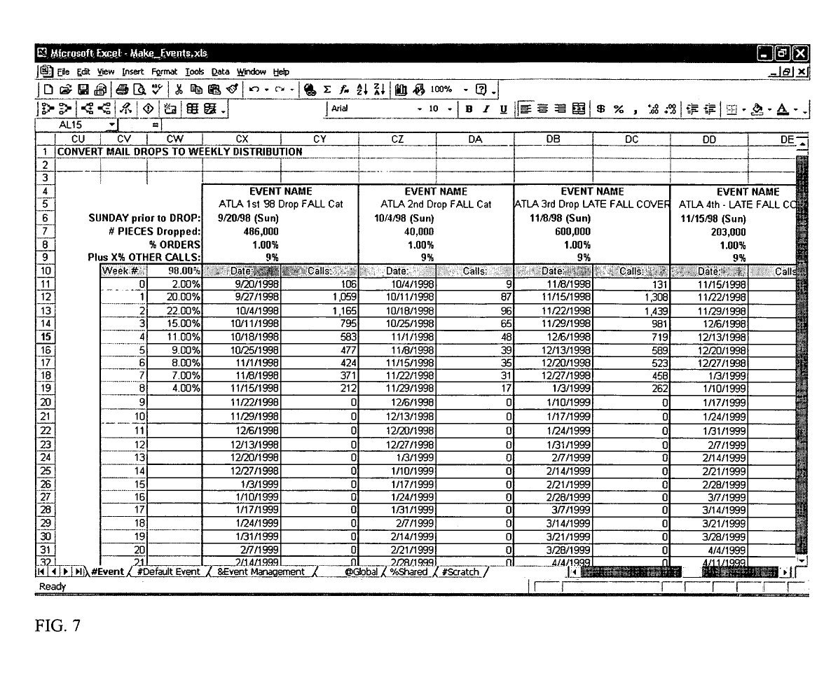

FIG. 7 shows Multiple Events. This screen represents that the weekly data for each event must be tabulated, then eventually summed up for further manipulations. The EBF may provide this illustration as a single depiction of multiple events, but it may be for a single event. The EBF calculates, for each event, the number of calls expected during each week.

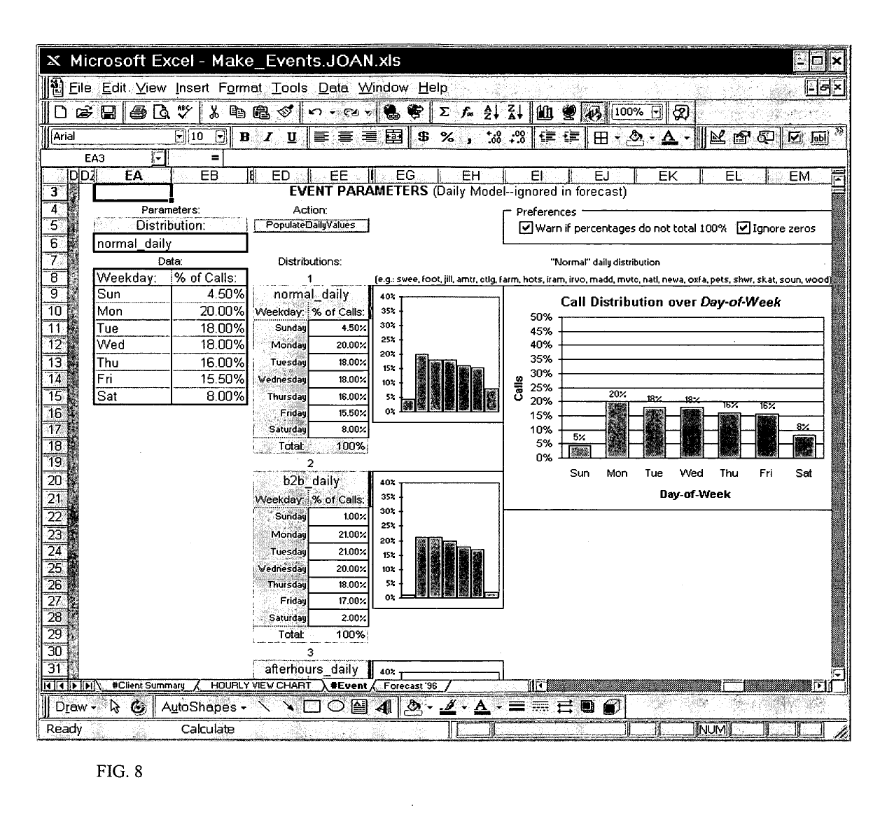

FIG. 8 shows Day of Week template selection. On this screen, the user selects the template to use for the “day of week,” i.e. the forecast model for each day of a week of the event. The small graphs down the middle of the screen are different templates that the user can select. Each template defines a different contact “trend”. When a template is selected, the column on the left side of the screen is filled in with percentages of contacts for each day of the week. The larger chart on the right side of the screen shows the result of the user's selections.

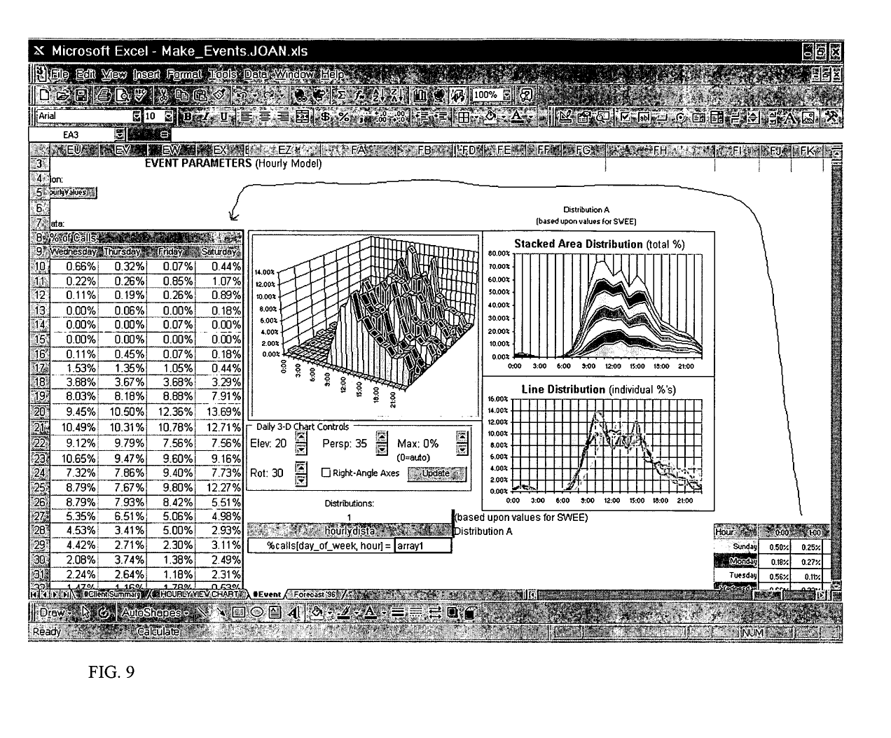

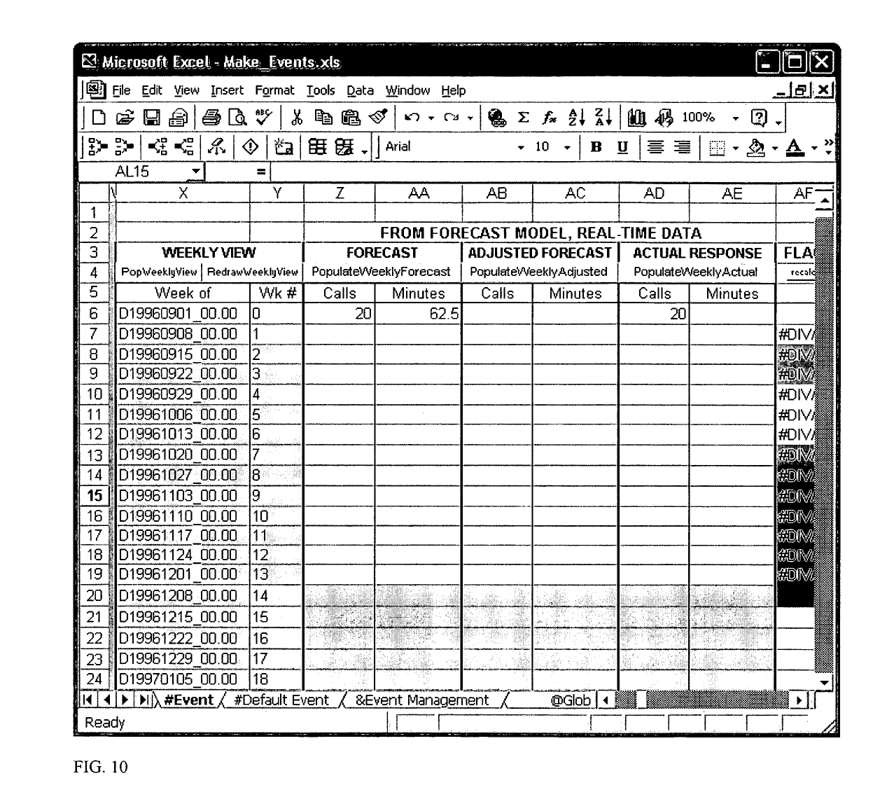

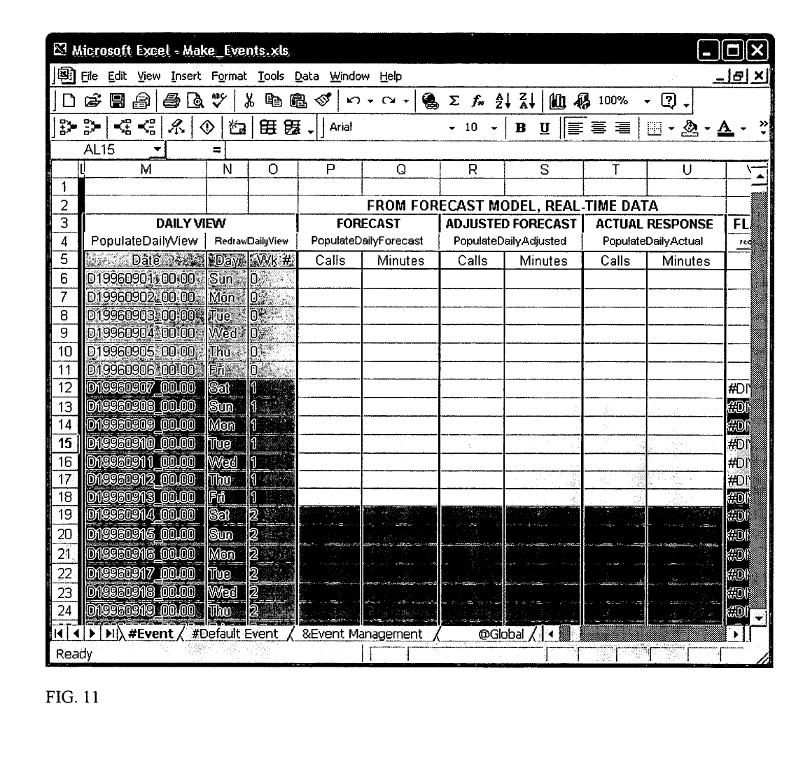

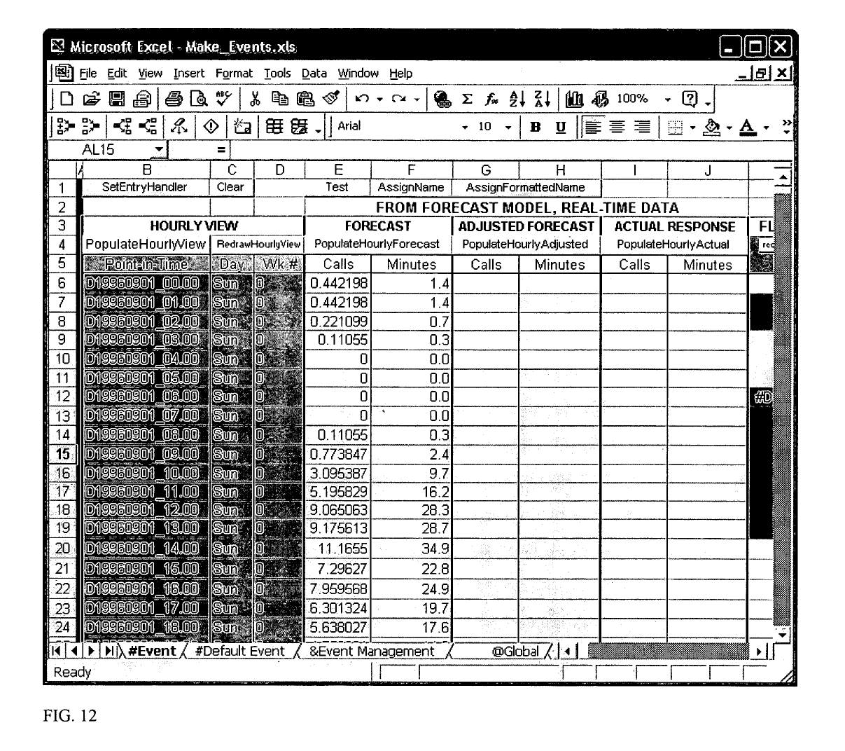

FIG. 9 shows Period of Week template selection. On this screen, a table on the left shows the percentage of contacts for each time period of a week of the event. In this aspect of the invention, the EBF calculates and populates a similar table, perhaps with user intervention. The three graphs on the screen are attempts to show different ways to display the data from the table. It is intended that a button on the screen is provided for the user to press and thereby automatically populate tables to hold the number of contacts and number of minutes for each week, day, and time period for the life of the event. Sample outputs for these data are shown in FIGS. 10-12. FIG. 10 shows Event Output for a week. FIG. 11 shows Event Output for each day of the week. FIG. 12 shows Event Output for each time period.

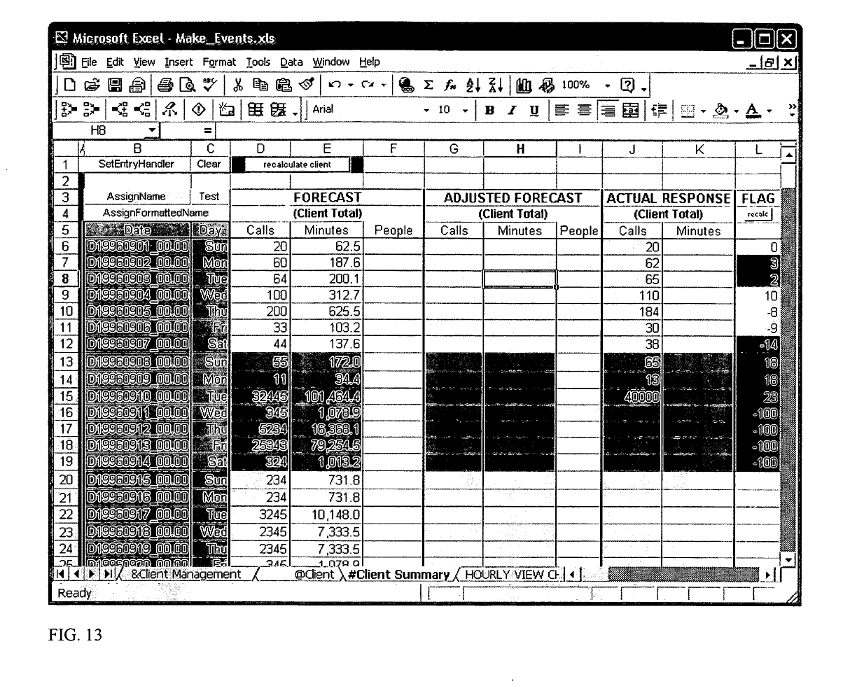

FIG. 13 shows Summary Information. After the indicated steps are completed for each event—and each contact type in each event, the output of all events is summarized into tables that hold the number of contacts and number of minutes for each week, day, and time period for the life of all events.

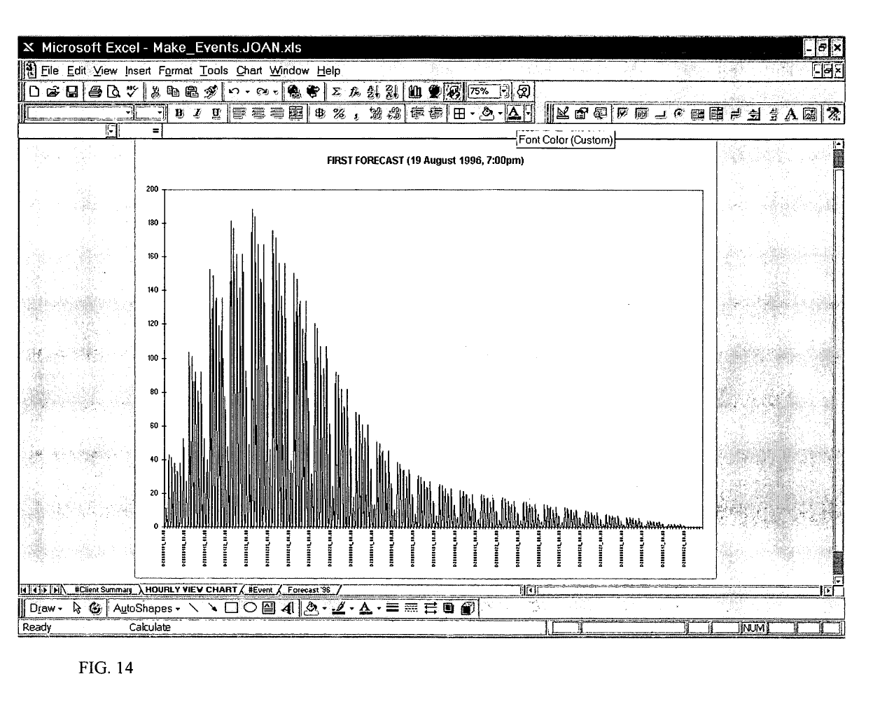

FIG. 14 shows Graph of an Event. This screen shows the resultant curve for an example single event for an example single contact type (calls).

The EBF is preferably deployed with an enterprise-class database such as, for example, Oracle, SQL Server, or a similar class of robust database. The following database types may be used MySQL, Informix Standard Engine Version 5.01, Access2000 desktop, SQL Server, or PostgreSQL. The following servers may be used to deploy the EBF: Linux and Windows are available for the database server. Informix runs under SCO UNIX emulation on Linux, MYSQL runs on Linux and Windows, Access2000 and SQL Server run on Windows. And PostgreSQL runs on Linux.

### Example Day-of-event Model

The Day-of-event model is used to distribute the total number of responses received over the life of the event. It is defined by a set of up to 365 percentage values, one for each day of an abstract year. The distribution algorithm should be user-selectable. Day-of-event models specify the frequency of contacts as a function of the time in days from the start of the event. (p=f(DOE) where p is the number of minutes expressed as a fraction of the total number of minutes over the life of the event and DOE is the number of days since the start of the event. The function f can be as simple as an array with one element for each day of the event, or some function generating a discrete frequency distribution. One such function that may prove useful is the Rayleigh function, p(x)=(2*X/R)*e^{-(x*x/R)}).

Period-of-week Model

The Period-of-week model is used to model the distribution of responses received over an ideal/standard week. It is defined by a set of percentage values (one for each time period—e.g. quarter hour, half-hour, or hour). Period-of-week models specify the distribution of minutes over the hours of the week as a fraction of the total number of minutes for the week. In most cases it will be a 672-element array, one element for each quarter-hour period of the week.

The processes, steps thereof and various examples and variations of these processes and steps, individually or in combination, may be implemented as a computer program product tangibly as computer-readable signals on a computer-readable medium, for example, a non-volatile recording medium, an integrated circuit memory element, or a combination thereof. Such computer program product may include computer-readable signals tangibly embodied on the computer-readable medium, where such signals define instructions, for example, as part of one or more programs that, as a result of being executed by a computer, instruct the computer to perform one or more processes or acts described herein, and/or various examples, variations and combinations thereof. Such instructions may be written in any of a plurality of programming languages, for example, Java, Visual Basic, C, or C++, Fortran, Pascal, Eiffel, Basic, COBOL, and the like, or any of a variety of combinations thereof. The computer-readable medium on which such instructions are stored may reside on one or more of the components of the EBF system described above and may be distributed across one or more such components. The steps described may be performed in different orders, one or more specific steps may be omitted, and one or more steps may be performed serially or in parallel.

A number of examples to help illustrate the invention have been described. Nevertheless, it will be understood that various modifications may be made without departing from the spirit and scope of the invention. Accordingly, other embodiments are within the scope of the claims appended hereto.

1. A method for predicting future resource allocation requirements of an organization based on one or more events, the method comprising the steps of:
a. inputting selectable event information determined to be relevant to the organization into a resource allocation calculator;
b. calculating future resource allocation information based upon the selectable inputted event information; and
c. forwarding the calculated future resource allocation information to a resource allocation function for specifying future resource allocation for the organization.

2. The method as claimed in claim 1 wherein the future resource allocation information includes one or more recommended staffing parameters.

3. The method as claimed in claim 2 wherein the one or more recommended staffing parameters are selected from a combination of one or more of the parameters of the group consisting of number of people, number of contacts, number of days, number of hours, number of quarter-hours, work week length, hours of day, service factor desired.

4. The method as claimed in claim 1 wherein the resource allocation function is a work force management tool.

5. The method as claimed in claim 1 further comprising the step of accessing the resource allocation calculator remotely for inputting the selectable event information, calculating the future resource allocation information, or both.

6. The method as claimed in claim 5 wherein the step of accessing is performed through an internet website.

7. The method as claimed in claim 1 further comprising the step of defining one or more events to be inputted to the resource allocation calculator as selected event and event segment information.

8. The method as claimed in claim 7 further comprising the step of summarizing the event information and the calculated future resource information calculated based on the inputted selected event information into one or more tables.

9. The method as claimed in claim 8 wherein the table includes one or more of: event parameters, event response distribution, critical event dates, event life expectancy, day of event, multiple events, day of week, period of week, event output per week, event output per day, event output per period, and summary.

10. The method as claimed in claim 1 wherein the event information includes one or more event segments, and wherein the event segments include known information, predictive information, or a combination of known information and predictive information.

11. The method as claimed in claim 10 wherein the event segments are selected from the group consisting of: mailings, television ads, radio ads, internet ads, new product releases, new service releases, promotions, trade shows, press releases, sales events, catalogs, advertising, the number of catalogs dropped, the offers made and their duration, the published life of the catalog, whether all catalogs are dropped from one location or multiple locations, the total number of responses expressed as a percentage of catalogs dropped, the percent of responses that are likely to be orders, literature requests, problems or general inquiries, the percent of responses expected to arrive via telephone, e-mail, fax, mail or in person, and the average work time required to handle each service type via each response type.

12. The method as claimed in claim 1 further comprising the step of repeating the step of calculating resource allocation information using as event information resource allocation information from a prior resource allocation information calculation.

13. A system to aid in the allocation of resources for future activities of an organization, the system comprising:
a. means for inputting selectable event information;
b. a calculation function for calculating resource allocation information from the inputted selectable event information; and
c. a forwarding function for forwarding the calculated resource allocation information to a resource allocation function for future allocation of resources for the organization.

14. The system as claimed in claim 13 wherein the event information includes one or more event segments, and wherein the event segments include known information, predictive information, or a combination of known information and predictive information.

15. The system as claimed in claim 14 wherein the events are selected from the group consisting of: mailings, television ads, new product releases, new service releases, promotions, trade shows, press releases, sales events, catalogs, and advertising.

16. The system as claimed in claim 13 wherein the organization is a contact center and the calculated resource allocation information includes number of people, work time periods and work time durations.

17. The system as claimed in claim 13 wherein the resource allocation function is a work force management tool.

18. The system as claimed in claim 13 configured for remotely inputting the selectable event information, remotely calculating the future resource allocation information, or both.

19. The system as claimed in claim 13 configured to summarize the event information and the calculated future resource information calculated based on the inputted selected event information into a table.

20. The system as claimed in claim 19 wherein the table includes one or more of: event parameters, event response distribution, critical event dates, event life expectancy, day of event, multiple events, day of week, period of week, event output per week, event output per day, event output per period, and summary.

21. The system as claimed in claim 13 wherein the means for inputting the selectable event information includes a computer with an information input device and a display, and one or more information input tables visible on the display.

22. The system as claimed in claim 21 wherein the one or more information input tables are arranged into sets of information input tables, wherein the sets are arranged by event type.

23. The system as claimed in claim 23 wherein the event types are direct mailings, periodicals, and broadcasts.

24. The system as claimed in claim 21 further comprising one or more event-based forecast tables that may be viewed on the display.

25. The system as claimed in claim 13 further comprising one or more databases for retaining therein events, event segments, and forecasts.

26. A method of forecasting staffing requirements for an organization based on the occurrence of one or more events, the method comprising the steps of:
a. inputting one or more event segments related to the one or more events into a database;
b. analyzing the one or more event segments individually or in selectable combinations to produce one or more forecasts; and
c. forwarding the one or more forecasts to a staffing allocation function for specifying future resource allocation for the organization.

27. The method as claimed in claim 26 wherein the event segments include known information, predictive information, or a combination of known information and predictive information.

28. The method as claimed in claim 27 wherein the known information includes one or more event segments selected from the group consisting of the type and size of a catalog, the number of catalogs dropped, inventory included, special offers made and their duration, the published life of the catalog, and whether all catalogs are dropped from one location or multiple locations, and the predictive information includes one or more event segments selected from the group consisting of the total number of responses expected, expressed as a percentage of catalogs dropped; the percent of responses that are likely to be orders, literature requests, problems or general inquiries (service types); the percent of responses expected to arrive via telephone, e-mail, fax, mail or in person (contact mode); and the average work time required to handle each service type via each contact mode.

29. The method as claimed in claim 26 further comprising the step of adding, subtracting, or modifying one or more of the event segments.

30. The method as claimed in claim 29 further comprising the step of repeating the step of analyzing the one or more event segments and creating a new set of forecasts.

31. The method as claimed in claim 30 further comprising the step of adding one or more prior forecasts as one or more event segments to be analyzed to produce a new set of forecasts.

32. The method as claimed in claim 30 further comprising the step of using variables from one or a collection of previous event segments and responses as a basis for provisioning one or more new event segments.

33. The method as claimed in claim 30 further comprising the step of retaining for access all forecasts produced.

34. The method as claimed in claim 26 further comprising the step of inputting the one or more event segments into a database using a computer with a display and an input device, wherein one or more input tables visible on the display are associated with the database.

35. The method as claimed in claim 34 further comprising the step of outputting the one or more forecasts to one or more output tables visible on the display, wherein the one or more output tables are associated with the database.

36. The method as claimed in claim 26 further comprising the step of providing a manual override to modify one or more forecasts based on human input.

37. The method as claimed in claim 26 wherein any event segment or event segment combination may be analyzed to produce a forecast related to the selected event segment or event segment combination.

38. A method of forecasting an event to conduct based on a desired outcome comprising the steps of:
a. inputting one or more forecasted outcomes desired into a database;
b. analyzing the one or more desired forecasted outcomes to produce one or more event segments; and
c. relating the one or more produced event segments to one or more events to conduct to produce the one or more desired forecasted outcomes.

39. The method as claimed in claim 38 wherein the one or more events are selected from the group consisting of mailings, television ads, new product releases, new service releases, promotions, trade shows, press releases, sales events, catalogs, and advertising.

40. The method as claimed in claim 38 wherein the event segments include known information, predictive information, or a combination of known information and predictive information.

41. The method as claimed in claim 40 wherein the known information includes one or more event segments selected from the group consisting of the type and size of a catalog, the number of catalogs dropped, inventory included, special offers made and their duration, the published life of the catalog, and whether all catalogs are dropped from one location or multiple locations, and the predictive information includes one or more event segments selected from the group consisting of the total number of responses expected, expressed as a percentage of catalogs dropped, the percent of responses that are likely to be orders, literature requests, problems or general inquiries (service types); the percent of responses expected to arrive via telephone, e-mail, fax, mail or in person (contact mode), and the average work time required to handle each service type via each contact mode.
